(19) United States
(12) Patent Application Publication
(10) Pub. No.: US 2008/0220362 A1
(43) Pub. Date: Sep. 11, 2008

(54) TONER COMPOSITIONS HAVING IMPROVED FUSING PROPERTIES

(75) Inventors: Emily L. MOORE, Mississauga (CA); Patricia A. BURNS, Oakville (CA); Michael L. GRANDE, Palmyra, NY (US); William H. HOLLENBAUGH, Rochester, NY (US); Edward G. ZWARTZ, Mississauga (CA); Shigang S. QIU, Etobicoke (CA); Maria N.V. MCDOUGALL, Oakville (CA); Daryl W. VANBESIEN, Burlington (CA); T. Brian MCANENEY, Burlington (CA)

Correspondence Address: OLIFF & BERRIDGE, PLC., P.O. BOX 320850, ALEXANDRIA, VA, 22320-4850, US

(73) Assignee: XEROX CORPORATION, Stamford, CT (US)

(21) Appl. No.: 11/682,612

(22) Filed: Mar. 6, 2007

(51) Int. Cl. G03G 13/16; G03G 15/10; G03G 9/08

(52) U.S. Cl. 430/113; 399/237; 430/125.33

(57) ABSTRACT

Image recording device comprising a development system including toner particles comprising a gel latex, a high Tg latex, a wax, and a colorant, and a fuser member, such as a fluoropolymer coated fuser member, which produces images having improved document offset, vinyl offset and half-tone rub properties.

### BACKGROUND

Disclosed herein is a toner composition for use in developing images in a xerographic device, for example a device including a fuser member to fuse the toner image to an image receiving substrate.

### REFERENCES

Toners used with fuser members, such as fuser members coated with polytetrafluoroethylene, are known in the art. For example, U.S. Publication No. 2006/0228639 to Young et al., which is incorporated herein in its entirety by reference, discloses toner containing both a low melt wax and a carnauba wax.

Fuser members, such as fuser rolls including an intermediate silicone material coated with polytetrafluoroethylene, have been found advantageous in handling a much wider range of paper weights and smoothness as compared to a polytetrafluoroethylene on metal fuser roll. Unfortunately, when such a polytetrafluoroethylene on silicone fuser roll is used with high melting polypropylene wax containing toners, the image receiving substrate, for example, paper, may not easily strip off the fuser roll. This may increase the amount of streaks in the prints.

Thus, it is still desired to develop a toner to be used with a fuser member including a fluoropolymer material, such as a polytetrafluoroethylene, on a silicone material, which toner achieves acceptable document offset, vinyl offset and crease properties when forming images in a device using such a fuser roll.

### SUMMARY

In embodiments, described herein is an image forming device, comprising a development system including an emulsion aggregation toner, and a fuser member, wherein the emulsion aggregation toner comprises a gel latex, a high Tg latex, a wax, and a colorant, and wherein the fuser member comprises a substrate and an outer layer comprising a fluoropolymer.

In further embodiments, described is an image forming process, comprising forming an electrostatic image on a photoconductive member; developing the electrostatic image to form a visible image by depositing emulsion/aggregation toner particles on a surface of the photoconductive member; and transferring the visible image to a substrate and fixing the visible image to the substrate with a fuser member; wherein the emulsion/aggregation toner comprises a gel latex, a high Tg latex, a wax, and a colorant, and wherein the fuser member comprises a substrate and an outer layer comprising a fluoropolymer.

In yet further embodiments, described is a toner composition having emulsion/aggregation toner particles comprising a gel latex, a high Tg latex, a wax, and a colorant, wherein a latitude of the gel latex around about a centerline particle formulation is about 10 weight percent±about 2 weight percent, a latitude of the high Tg latex around about a centerline particle formulation is about 68 weight percent±about 2 weight percent, a latitude of the wax around about a centerline particle formulation is about 12 weight percent±about 1 weight percent, and a latitude of the colorant around about a centerline particle formulation is about 10 weight percent±about 1 weight percent, and wherein the high Tg latex has a glass transition temperature of from about 53° C. to about 58° C.

### EMBODIMENTS

The toner described herein when used with the fuser roll described herein provides images on substrates with acceptable document offset, vinyl offset, crease properties and half-tone rub.

Document offset refers to how well the toner remains on the image recording medium, such as paper, plastic, cardboard and the like, after the image has been printed. This is particularly important when the printed items are to be stacked upon each other after formation.

After documents are created, they can be stored in contact with vinyl surfaces, such as used in file folders and three ring binders, or in contact with the surface of other documents. Occasionally, finished documents adhere and offset to these surfaces resulting in image degradation; this is known as vinyl offset in the case of offset to vinyl surfaces or document offset in the case of offset to other documents. Some toner binder resins are more susceptible to this phenomenon than others. The chemical composition of the toner binder resin and the addition of certain ingredients can minimize or prevent vinyl and document offset.

Document offset is generally measured for both toner-toner and toner-paper offset, by peeling apart samples to determine the amount of toner that has been transferred. Document offset is generally ranked using the Standard Image Reference (SIR) in which Grade 5 indicates damage and Grade 1 indicates severe damage. In embodiments, the SIR for both toner-toner and toner-paper offset is at least about 3, such as from about 3.5 to about 5 or from about 4 to about 5. Vinyl offset is generally measured in a similar manner to document offset, expect that the toner from a toner image is transferred to a vinyl. As with document offset, the SIR for vinyl offset is at least about 3, such as from about 3.5 to about 5 or from about 4 to about 5.

Crease property refers to how well an image avoids cracking when the image is folded or creased.

Half-tone rub refers to how well the toner remains on the image recording substrate, such as paper or a package, when the image has a gray tone. “Gray tone” refers to an image that is not solid, but is instead imaged with, for example, a black toner such that the printed image appears a lighter shade of the toner, such as for example, a printed gray image from a black toner. Without limiting this disclosure, it is believed that gray tone images do not adhere well to the substrate because there is insufficient lateral anchoring. Specifically, the toner particles that form the gray tone image are not sufficient in quantity to anchor each other. Thus, the toner particles of the gray tone image may be more easily removed from the substrate.

The toner may be emulsion aggregation (E/A) toner, although the toner may also be prepared by other chemical and/or physical methods as well. In view of the ease in controlling particle size and uniformity, E/A toners are particularly suitable. The toner disclosed herein comprise a wax, a high glass transition temperature (Tg) latex, a gel latex, and a colorant.

Examples of waxes suitable for use herein include aliphatic waxes such as hydrocarbon waxes having about 1 carbon atom to about 30 carbon atoms, such as from about 1 carbon atom to about 30 carbon atoms or from about 1 carbon atom to about 25 carbon atoms, polyethylene, polypropylene or mixtures thereof.

More specific examples of waxes suitable for use herein include polypropylene and polyethylene waxes commercially available from Allied Chemical and Petrolite Corporation, wax emulsions available from Michaelman Inc. and the Daniels Products Company, EPOLENE N-15™ commercially available from Eastman Chemical Products, Inc., VISCOL 550-P™, a low weight average molecular weight polypropylene available from Sanyo Kasei K.K., and similar materials. Commercially available polyethylenes possess, it is believed, a molecular weight (Mw) of about 500 to about 5,000, and commercially available polypropylenes are believed to possess a molecular weight of about 4,000 to about 10,000. Examples of functionalized waxes include amines, amides, for example AQUA SUPERSLIP 6550™, SUPERSLIP 6530™ available from Micro Powder Inc., fluorinated waxes, for example POLYFLUO 190™, POLYFLUO 200™, POLYFLUO 523XF™, AQUA POLYFLUO 411™, AQUIA POLYSILK 19™, and POLYSILK 14T™ available from Micro Powder Inc., mixed fluorinated, amide waxes, for example MICROSPERSION 19™ also available from Micro Powder Inc., imides, esters, quaternary amines, carboxylic acids or acrylic polymer emulsion, for example JONCRYL 74™, 89™, 130™, 537™, and 538™, all available from SC Johnson Wax, and chlorinated polypropylenes and polyethylenes available from Allied Chemical and Petrolite Corporation and SC Johnson Wax.

In embodiments, the wax comprises a wax in the form of a dispersion comprising, for example, a wax having a particle diameter of from about 100 nanometers to about 500 nanometers, water, and an anionic surfactant. In embodiments, the wax is included in amounts such as from about 2 to about 40 weight percent. The latitude of the wax around about the centerline toner particle formulation may be about 12 weight percent ═about 1 weight percent. In embodiments, the wax comprises polyethylene wax particles, such as POLYWAX 850, POLYWAX 725 and POLYWAX 655, commercially available from Baker Petrolite, having a particle diameter in the range of about 100 to about 500 nanometers.

As used herein “centerline toner particle formulation” refers to the ideal formulation of the toner particles disclosed herein. The term “latitude” refers to the variation possible in the formulation while still achieving the features associated with the centerline toner particle formulation.

The toner particles disclosed herein also include a high Tg latex.

For example, the high Tg latex comprises latex comprising monomers, such as styrene, butyl acrylate, and beta-carboxyethylacrylate (beta-CEA) monomers prepared, for example, by emulsion polymerization in the presence of an initiator, a chain transfer agent (CTA), and surfactant.

Instead of beta-CEA, the high Tg latex may include any carboxyl acid containing monomer, such as maleic acid, citraconic acid, itaconic acid, alkenyl succinic acid, fumaric acid, mesaconic acid, maleic-acid anhydride, citraconic anhydride, itaconic-acid anhydride, alkenyl succinic-acid anhydride, maleic-acid methyl half ester, maleic-acid ethyl half ester, maleic-acid butyl half ester, citraconic-acid methyl half ester, citraconic-acid ethyl half ester, citraconic-acid butyl half ester, itaconic-acid methyl half ester, alkenyl succinic-acid methyl half ester, fumaric-acid methyl half ester, half ester of the partial saturation dibasic acid such as mesaconic acid methyl half ester, dimethyl maleic acid, the partial saturation dibasic acid ester such as dimethyl fumaric acid, acrylic acid, methacrylic acid, alpha like crotonic acid, cinnamon acid, beta-partial saturation acid, crotonic-acid anhydride, cinnamon acid anhydride, alkenyl malonic acid, a monomer which has an alkenyl glutaric acid, and alkenyl adipic acids.

In embodiments, the high Tg latex comprises styrene:butyl acrylate:beta-CEA wherein, for example, the high Tg latex monomers include from about 70 weight percent to about 90 weight percent styrene, from about 10 weight percent to about 30 weight percent butyl acrylate, and from about 0.05 weight percent to about 10 weight percent beta-CEA.

In embodiments, the toner comprises high Tg latex in an amount of from about 50 weight percent to about 95 weight percent of the total weight of the toner described herein, such as 65 weight percent to about 80 of the total weight of the toner described herein. The latitude loading of the high Tg latex around about the centerline particle formulation may be about 68 weight percent±about 2 weight percent, such as about 68 weight percent±about 1 weight percent.

The high Tg latex disclosed herein that is substantially free of crosslinking and has a crosslinked density less than about 0.1 percent, such as less than about 0.05. As used herein “crosslink density” refers to the mole fraction of monomer units that are crosslinking points. For example, in a system where 1 of every 20 molecules is a divinylbenzene and 19 of every 20 molecules is a styrene, only 1 of 20 molecules would crosslink. Thus, in such a system, the crosslinked density would be 0.05.

The onset Tg (glass transition temperature) of the high Tg latex may be from about 53° C. to about 70° C., such as from about 53° C. to about 67° C. or from about 53° C. to about 58° C., or such as about 55° C.

The weight average molecular weight (Mw) of the high Tg latex may be from about 20,000 to about 60,000, such as from about 30,000 to about 40,000, or about 35,000.

The gel latex may be prepared from a high Tg latex, such as a latex comprising monomers of styrene, butyl acrylate, beta-CEA, divinylbenzene, a surfactant and an initiator. Instead of the beta-CEA, the gel latex may include a carboxyl acid containing monomer as described above. The gel latex may be prepared by emulsion polymerization.

In embodiments, the crosslinked density of the gel latex is from about 0.3 percent to about 40 percent, such as from about 0.3 percent to about 35 percent or from about 0.3 percent to about 30 percent crosslinked density.

In embodiments, the toner comprises gel latex in an amount of from about 3 weight percent to about 30 weight percent of the total weight of the toner described herein, such as 5 weight percent to about 15 of the total weight of the toner described herein. The latitude of the gel latex around about the centerline particle formulation may be about 10 weight percent±about 2 weight percent.

Other latexes suitable for preparing the high Tg latex and the gel latex include styrene acrylates, styrene methacrylates, butadienes, isoprene, acrylonitrile, acrylic acid, methacrylic acid, beta-carboxy ethyl acrylate, polyesters, known polymers such as poly(styrene-butadiene), poly(methyl styrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methyl styrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene), poly(styrene-propyl acrylate), poly(styrene-butyl acrylate), poly(styrene-butadiene-acrylic acid), poly(stylene-butadiene-methacrylic acid), poly(styrene-butyl acrylate-acrylic acid), poly(styrene-butyl acrylate-methacrylic acid), poly(styrene-butyl acrylate-acrylonitrile), poly(styrene-butyl acrylate-acrylonitrile-acrylic acid), and the like. In embodiments, the resin or polymer is a styrene/butyl acrylate/beta-carboxyethylacrylate terpolymer.

An initiator suitable for use in producing both the gel latex and the high Tg latex may be, for example, sodium, potassium or ammonium persulfate and may be present in with both the crosslinking starting monomers and non-crosslinking starting monomers in the range of from about 0.1 weight percent to about 5 weight percent, such as from about 0.3 weight percent to about 4 weight percent or from about 0.5 weight percent to about 3 weight percent of an initiator based upon the total weight of the monomers. In embodiments, the surfactant may be present in the range of from about 0.3 weight percent to about 10 weight percent, such as from about 0.5 weight percent to about 8 weight percent or from about 0.7 to about 5.0 weight percent of surfactant.

Both the gel latex and the high Tg latex may be produced by similar methods. However, in producing the high Tg latex, no divinylbenzene or similar crosslinking agent is used. Examples of crosslinking agents suitable for making the gel latex include divinylbenzene, divinylnaphthalene, ethylene glycol diacrylate, 1,3-butylene-glycol diacrylate, 1,4-butanediol diacrylate, 1,5-pentanediol diacrylate, 1,6-hexanediol diacrylate, neopentyl glycol diacrylate, diethylene glycol diacrylate, triethylene glycol diacrylate, tetraethylene glycol diacrylate, polyethylene-glycol #400 diacrylate, dipropylene glycol diacrylate, and polyoxyethylene (2)-2,2-bis(4-hydroxyphenyl) propane diacrylate.

The gel latex and high Tg latex may be made by any suitable method. One example of a suitable method is described below for illustration.

First, a surfactant solution is prepared by combining a surfactant with water. Surfactants suitable for use herein may be anionic, cationic or nonionic surfactants in effective amounts of, for example, from about 0.01 to about 15, or from about 0.01 to about 5 weight percent of the reaction mixture.

Anionic surfactants include sodium dodecylsulfate (SDS), sodium dodecylbenzene sulfonate, sodium dodecylbenzene sulfonate, sodium dodecylnaphthalene sulfate, dialkyl benzenealkyl, sulfates and sulfonates, abitic acid, available from Aldrich, NEOGEN R™, NTEOGEN SC™ obtained from Kao, and the like.

Examples of cationic surfactants include dialkyl benzene alkyl ammonium chloride, lauryl trimethyl ammonium chloride, alkylbenzyl methyl ammonium chloride, alkyl benzyl dimethyl ammonium bromide, benzalkonium chloride, cetyl pyridinium bromide, C₁₂, C₁₅, C₁₇ trimethyl ammonium bromides, halide salts of quaternized polyoxyethylalkylamines, dodecyl benzyl triethyl ammonium chloride, MIRAPOL and ALKAQUAT available from Alkaril Chemical Company, SANISOL (benzalkonium chloride), available from Kao Chemicals, SANISOL B-50 available from Kao Corp., which consists primarily of benzyl dimethyl alkonium chloride, and the like.

Examples of nonionic surfactants include polyvinyl alcohol, polyacrylic acid, methalose, methyl cellulose, ethyl cellulose, propyl cellulose, hydroxy ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxy poly(ethyleneoxy) ethanol, available from Rhone-Poulenac as IGEPAL CA-210™, IGEPAL CA-520™, IGEPAL CA-720™, IGEPAL CO 890™, IGEPAL CO-720™, IGEPAL CO-290™, IGEPAL CA-210™, ANTAROX 890™, ANTAROX 897™, and mixtures thereof.

In a separate container, an initiator solution is prepared. Examples of initiators for the preparation of the latex include water soluble initiators, such as ammonium and potassium persulfates in suitable amounts, such as from about 0.1 to about 8 weight percent, and more specifically, in the range of from about 0.2 to about 5 weight percent.

In yet another container, a monomer emulsion is prepared by mixing the monomer components of the latex, such as styrene, butyl acrylate, beta-CEA, optionally divinylbenzene if producing the gel latex, and surfactant with water. In one embodiment, the styrene, butyl acrylate, and/or beta-CEA are olefinic monomers.

Once the preparation of the monomer emulsion is complete, a small portion, for example, about 0.5 to about 5 percent of the emulsion, may be slowly fed into a reactor containing the surfactant solution. The initiator solution may be then slowly added into the reactor. After about 15 to about 45 minutes, the remainder of the emulsion is added into the reactor.

After about 1 to about 2 hours, but before all of the emulsion is added to the reactor, 1-dodecanethiol or carbon tetrabromide (chain transfer agents that control/limit the length of the polymer chains) is added to the emulsion. In embodiments, the charge transfer agent may be used in effective amounts of, for example, from about 0.05 weight percent to about 15 weight percent of the starting monomers, such as from about 0.1 weight percent to about 13 weight percent or from about 0.1 weight percent to about 10 weight percent of the starting monomers. The emulsion is continued to be added into the reactor.

The monomers may be polymerized under starve fed conditions as referred to in U.S. Pat. No. 6,447,974, incorporated by reference herein in its entirety, to provide latex resin particles having a diameter in the range of from about 20 nanometers to about 500 nanometers, such as from about 75 nanometers to about 400 nanometers or from about 100 to about 300 nanometers.

Colorants or pigments include pigments, dyes, mixtures of pigments and dyes, mixtures of pigments, mixtures of dyes, and the like. In embodiments, the colorant comprises a pigment, a dye, mixtures thereof, carbon black, magnetite, black, cyan, magenta, yellow, red, green, blue, brown, mixtures thereof, in an amount of about 1 weight percent to about 25 weight percent by weight based upon the total weight of the toner composition, such as from about 2 weight percent to about 20 weight percent or from about 5 weigh percent to about 15 weight percent based upon the total weight of the toner composition. In embodiments, the latitude of colorant around about a centerline particle formulation is about 10 weight percent±about 1 weight percent based upon the total weight of the toner composition. It is to be understood that other useful colorants will become readily apparent to one of skill in the art based on the present disclosure.

In general, useful colorants include Paliogen Violet 5100 and 5890 (BASF), Normandy Magenta RD-2400 (Paul Uhlrich), Permanent Violet VT2645 (Paul Uhlrich), Heliogen Green L8730 (BASF), Argyle Green XP-111-S (Paul Uhlrich), Brilliant Green Toner GR 0991 (Paul Uhlrich), Lithol Scarlet D3 700 (BASF), Toluidine Red (Aldrich), Scarlet for Thermoplast NSD Red (Aldrich), Lithol Rubine Toner (Paul Uhlrich), Lithol Scarlet 4440, NBD 3700 (BASF), Bon Red C (Dominion Color), Royal Brilliant Red RD-8192 (Paul Uhlrich), Oracet Pink RF (Ciba Geigy), Paliogen Red 3340 and 3871K (BASF), Lithol Fast Scarlet L4300 (BASF), Heliogen Blue D6840, D7080, K7090, K6910 and L7020 (BASF), Sudan Blue OS (BASF), Neopen Blue FF4012 (BASF), PV Fast Blue B2G01 (American Hoechst), Irgalite Blue BCA (Ciba Geigy), Paliogen Blue 6470 (BASF), Sudan II, III and IV (Matheson, Coleman, Bell), Sudan Orange (Aldrich), Sudan Orange 220 (BASF), Paliogen Orange 3040 (BASF), Ortho Orange OR 2673 (Paul Uhlrich), Paliogen Yellow 152 and 1560 (BASF), Lithol Fast Yellow 0991K (BASF), Paliotol Yellow 1840 (BASF), Novaperm Yellow FGL, (Hoechst), Permanerit Yellow YE 0305 (Paul Uhlrich), Lumogen Yellow D0790 (BASF), Suco-Gelb 1250 (BASF), Suco-Yellow D1355 (BASF), Suco Fast Yellow D1165, D1355 and D1351 (BASF), Hostaperm Pink E (Hoechst), Fanal Pink D4830 (BASF), Cinquasia Magenta (DuPont), Paliogen Black L9984 9BASF), Pigment Black K801 (BASF) and particularly carbon blacks such as REGAL 330 (Cabot), Carbon Black 5250 and 5750 (Columbian Chemicals), and the like or mixtures thereof.

Additional useful colorants include pigments in water based dispersions such as those commercially available from Sun Chemical, for example SUNSPERSE BHD 6011X (Blue 15 Type), SUNSPERSE BHD 9312X (Pigment Blue 15 74160), SUNSPERSE BHD 6000X (Pigment Blue 15:3 74160), SUNSPERSE GHD 9600X and GHD 6004X (Pigment Green 7 74260), SUNSPERSE QHD 6040X (Pigment Red 122 73915), SUNSPERSE RHD 9668X (Pigment Red 185 12516), SUNSPERSE RHD 9365X and 9504X (Pigment Red 57 15850:1, SUNSPERSE YHD 6005X (Pigment Yellow 83 21108), FLEXIVERSE YFD 4249 (Pigment Yellow 17 21105), SUNSPERSE YHD 6020X and 6045X (Pigment Yellow 74 11741), SUNSPERSE YHD 600X and 9604X (Pigment Yellow 14 21095), FLEXIVERSE LFD 4343 and LFD 9736 (Pigment Black 7 77226) and the like or mixtures thereof. Other useful water based colorant dispersions include those commercially available from Clariant, for example, HOSTAFINE Yellow GR, HOSTAFINE Black T and Black TS, HOSTAFINE Blue B2G, HOSTAFINE Rubine F6B and magenta dry pigment such as Toner Magenta 6BVP2213 and Toner Magenta EO2 which can be dispersed in water and/or surfactant prior to use.

Other useful colorants include, for example, magnetites, such as Mobay magnetites M08029, M08960; Columbian magnetites, MAPICO BLACKS and surface treated magnetites; Pfizer magnetites CB4799, CB5300, CB5600, MCX6369; Bayer magnetites, BAYFERROX 8600, 8610; Northern Pigments magnetites, NP-604, NP-608; Magnox magnetites TMB-100 or TMB-104; and the like or mixtures thereof. Specific additional examples of pigments include phthalocyanine HELIOGEN BLUE L6900, D6840, D7080, D7020, PYLAM OIL BLUE, PYLAM OIL YELLOW, PIGMENT BLUE 1 available from Paul Uhlrich & Company, Inc., PIGMENT VIOLET 1, PIGMENT RED 48, LEMON CHROME YELLOW DCC 1026, E.D. TOLUIDINIE RED and BON RED C available from Dominion Color Corporation, Ltd., Toronto, Ontario, NOVAPERM YELLOW FGL, HOSTAPERM PINK E from Hoechst, and CINQUASIA MAGENTA available from E.I. DuPont de Nemours & Company, and the like. Examples of magentas include, for example, 2,9-dimethyl substituted quinacridone and anthraquinone dye identified in the Color Index as CI 60710, CI Dispersed Red 15, diazo dye identified in the Color Index as CI 26050, CI Solvent Red 19, and the like or mixtures thereof. Illustrative examples of cyans include copper tetra(octadecyl sulfonamide) phthalocyanine, x-copper phthalocyanine pigment listed in the Color Index as CI74160, CI Pigment Blue, and Anthrathrene Blue identified in the Color Index as DI 69810, Special Blue X-2137, and the like or mixtures thereof. Illustrative examples of yellows that may be selected include diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33 2,5-dimethoxy-4-sulfonanilide phenylazo-4′-chloro-2,4-dimethoxy acetoacetanilide, and Pemanent Yellow FGL. Colored magnetites, such as mixtures of MAPICO BLACK and cyan components may also be selected as pigments.

The toner particles may be made by any known procedure, for example an emulsion/aggregation process. An example of such a process suitable for use herein includes forming a mixture of the high Tg latex, the gel latex, wax and colorant, and deionized water in a vessel with a flocculating agent. This refers to a “bulk addition” of the wax, where the wax is added to the mixture including all of the components of the toner particles. The mixture is then stirred using a homogenizer until homogenized and then transferred to a reactor where the homogenized mixture is heated to a temperature of, for example, about 50° C. and held at such temperature for a period of time to permit aggregation of toner particles to the desired size. In embodiments, a “delayed addition” of the wax may be utilized. In such a “delayed addition,” the wax may be added to the mixture after the mixture of high Tg latex, gel latex and colorant and flocculent is homogenized.

Regardless of the manner in which the wax is added to the mixture, once the desired size of aggregated toner particles is achieved, the pH of the mixture is adjusted in order to inhibit further toner aggregation. The toner particles are further heated to a temperature of, for example, about 90° C. and the pH lowered in order to enable the particles to coalesce and spherodize. The heater is then turned off and the reactor mixture allowed to cool to room temperature, at which point the aggregated and coalesced toner particles are recovered and optionally washed and dried.

Dilute solutions of flocculates or aggregating agents may be used to optimize particle aggregation time with as little fouling and coarse particle formation as possible. Examples of flocculates or aggregating agents may include polyaluminum chloride (PAC), dialkyl benzenealkyl ammonium chloride, lauryl trimethyl ammonium chloride, alkylbenzyl methyl ammonium chloride, alkyl benzyl dimethyl ammonium bromide, benzalkonium chloride, cetyl pyridinium bromide, C₁₂, C₁₅, C₁₇ trimethyl ammonium bromides, halide salts of quaternized polyoxyethylalkylamines, dodecylbenzyl triethyl ammonium chloride, MIRAPOL™ and ALKAQUAT™ (available from Alkaril Chemical Company), SANIZOL™ (benzalkonium chloride) (available from Kao Chemicals), and the like, and mixtures thereof.

In embodiments, the flocculates or aggregating agents may be used in an amount of from about 0.01 weight percent to about 10 weight percent of the toner composition, such as from about 0.02 weight percent to about 5 weight percent or from about 0.05 weight percent to about 2 weight percent. For example, the latitude of flocculates or aggregating agents around about a centerline particle formulation is about 0.17 weight percent±about 0.02 weight percent based upon the total weight of the toner composition. The size of the formed toner particles may be from about 3 μm to about 8 μm, such as a toner particle size of from about 4.5 μm to about 7 μm or from about 5 μm to about 6 μm.

The circularity may be determined using the known Malvern Sysmex Flow Particle Image Analyzer FPIA-2100. The circularity is a measure of the particles closeness to a perfect sphere. A circularity of 1.0 identifies a particle having the shape of a perfect circular sphere. The toner particles described herein may have a circularity of from about 0.9 to about 1.0, such as from about 0.93 to about 1.0 or from about 0.95 to about 1.0.

The developed toner mass per unit area (TMA) suitable for the printed images from the toner described herein may be in the range of from about 0.35 mg/cm² to about 0.55 mg/cm² such as from about 0.4 mg/cm² to 0.5 about mg/cm² or from about 0.43 mg/cm² to about 0.47 mg/cm².

The onset Tg (glass transition temperature) of the toner particles may be from about 40° C. to about 65° C. such as from about 45° C. to about 60° C. or from about 50° C. to about 55° C.

The rub fix data, measured by measuring transmission optical density with a Greatag/Macbeth Spectroscan Transmission densitometer, of the toner particles disclosed herein is less than or equal to about 0.20 ODtr, such as from about 0 ODtr to about 0.18 ODtr or from about 0 ODtr to about 0.12 ODtr.

The toner particles also have a size such that the upper geometric standard deviation (GSDv) by volume for (D84/D50) is in the range of from about 1.15 to about 1.25, such as from about 1.18 to about 1.23. The particle diameters at which a cumulative percentage of 50% of the total toner particles are attained are defined as volume D50, which are from about 5.45 to about 5.88, such as from about 5.47 to about 5.85. The particle diameters at which a cumulative percentage of 84% are attained are defined as volume D84. These aforementioned volume average particle size distribution indexes GSDv can be expressed by using D50 and D84 in cumulative distribution, wherein the volume average particle size distribution index GSDv is expressed as (volume D84/volume D50). The upper GSDv value for the toner particles indicates that the toner particles are made to have a very narrow particle size distribution.

It may also be desirable to control the toner particle size and limit the amount of both fine and coarse toner particles in the toner. The toner particles may have a very narrow particle size distribution with a lower number ratio geometric standard deviation (GSDn), which is express as (number D50/number D16), of from about 1.20 to about 1.30, such as from about 1.22 to about 1.29.

The toner particles described herein also exhibit acceptable toner cohesion. Toner cohesion may be measured using a Hosokawa Micron PT-R tester, available from Micron Powders Systems. Toner cohesion is typically expressed in percent (%) cohesion. Percent cohesion may be measured by placing a known mass of toner, for example 2 grams, on top of a set of stacked screens, for example a top screen that has 53 micron mesh or openings, a middle screen that has 45 micron mesh or openings, and a bottom screen that has 38 micron mesh or openings, and vibrating the screens and toner for a fixed time at a fixed vibration amplitude, for example for 90 seconds at 1 millimeter vibration amplitude. All screens are made of stainless steel. The percent cohesion is then calculated as follows:

% cohesion=50·A+30·B+10·C

where A is the mass of toner remaining on the 53 micron screen, B is the mass of toner remaining on the 45 micron screen, and C is the mass of toner remaining on the 38 micron screen. The percent cohesion of the toner is related to the amount of toner remaining on each of the screens at the end of the time. A percent cohesion value of 100% corresponds to all the toner remaining on the top screen at the end of the vibration step and a percent cohesion of 0% corresponds to all of the toner passing through all three screens, in other words, no toner remaining on any of the three screens at the end of the vibration step. The greater the percent cohesion for toners, the less the toner particles are able to flow. In embodiments, the toners may have a percent cohesion in the range of, for example, from about 30% to about 80%, such as from about 35% to about 75%, or from about 40% to about 65%.

In embodiments herein, the toner particles may have an acceptable blocking temperature. Blocking temperatures are determined based on a blocking procedure. The blocking procedure measures the toner cohesion at varying elevated temperatures to determine the temperature at which the toner of the developer starts to stick together due to exposures to elevated temperature. The blocking temperature may be defined as the highest temperature step before there is a large continuous increase of cohesion. In other words, the blocking temperature is a temperature when the toner has greater than 20% cohesion increase within a 1° C. temperature rise. The blocking temperature of the toner particles disclosed herein may be from about 52° C. to about 60° C., such as from about 53° C. to about 59.5° C. or from about 53.5° C. to about 59° C. (see, for example, Table 3 below).

In an image forming process, an image forming device is used to form a print, typically a copy of an original image. An image forming device imaging member (for example, a photoconductive member) including a photoconductive insulating layer on a conductive layer, is imaged by first uniformly electrostatically charging the surface of the photoconductive insulating layer. The member is then exposed to a pattern of activating electromagnetic radiation, for example light, which selectively dissipates the charge in the illuminated areas of the photoconductive insulating layer while leaving behind an electrostatic latent image in the non-illuminated areas. This electrostatic latent image may then be developed to form a visible image by depositing the toner particles, for example from a developer composition, on the surface of the photoconductive insulating layer. A development system be suitable for use herein may be a conductive magnetic brush development system. In embodiments, a CMB developer can be used in various systems, for example a semiconductive magnetic brush development system, which uses a semiconductive carrier. A semi-conductive magnetic brush development (SCMB) system, which uses semiconductive carriers, advances the developer material into contact with the electrostatic latent image. When the developer material is placed in a magnetic field, the carrier granules (particles) with the toner particles thereon form what is known as a magnetic brush? wherein the carrier beads form relatively long chains, which resemble the fibers of a brush. This magnetic brush is typically created by means of a developer roll in the form of a cylindrical sleeve rotating around a fixed assembly of permanent magnets. The carrier granules form chains extending from the surface of the cylindrical sleeve. The toner particles are electrostatically attracted to the chains of carrier granules. The rotation of the sleeve transports magnetically adhered developer material comprising carrier granules and toner particles and allows direct contact between the developer brush and a belt having a photoconductive surface. The electrostatic latent image attracts the toner particles from the carrier granules forming a toner power image on the photoconductive surface of the belt.

The resulting visible toner image can be transferred to a suitable image receiving substrate such as paper and the like.

To fix the toner to the image receiving substrate, such as a sheet of paper or transparency, hot roll fixing is commonly used. In this method, the image receiving substrate with the toner image thereon is transported between a heated fuser member and a pressure member with the image face contacting the fuser member. Upon contact with the heated fuser member, the toner melts and adheres to the image receiving medium, forming a fixed image. This fixing system is very advantageous in heat transfer efficiency and is especially suited for high speed electrophotographic processes.

Fixing performance of the toner can be characterized as a function of temperature. The lowest temperature at which the toner adheres to the support medium is referred to as the Cold Offset Temperature (COT), and the maximum temperature at which the toner does not adhere to the fuser member is referred to as the Hot Offset Temperature (HOT). When the fuser temperature exceeds HOT, some of the molten toner adheres to the fuser member during fixing and is transferred to subsequent substrates containing developed images resulting, for example, in blurred images. This undesirable phenomenon is known as offsetting. Between the COT and HOT of the toner is the Minimum Fix Temperature (MFT), which is the minimum temperature at which acceptable adhesion of the toner to the image receiving substrate occurs, as determined by, for example, a creasing test. The difference between MFT and HOT is referred to as the fusing latitude.

The fuser member suitable for use herein comprises at least a substrate and an outer layer. Any suitable substrate can be selected for the fuser member. The fuser member substrate may be a roll, belt, flat surface, sheet, film, drelt (a cross between a drum or a roller), or other suitable shape used in the fixing of thermoplastic toner images to a suitable copy substrate. Typically, the fuser member is a roll made of a hollow cylindrical metal core, such as copper, aluminum, stainless steel, or certain plastic materials chosen to maintain rigidity and structural integrity, as well as being capable of having a polymeric material coated thereon and adhered firmly thereto. The supporting substrate may be a cylindrical sleeve, preferably with an outer fluoropolymeric layer of from about 1 to about 6 millimeters. In one embodiment, the core, which can be an aluminum or steel cylinder, is degreased with a solvent and cleaned with an abrasive cleaner prior to being primed with a primer, such as DOW CORNING® 1200, which can be sprayed, brushed, or dipped, followed by air drying under ambient conditions for thirty minutes and then baked at about 150° C. for about 30 minutes.

Also suitable are quartz and glass substrates. The use of quartz or glass cores in fuser members allows for a lightweight, low cost fuser system member to be produced. Moreover, the glass and quartz help allow for quick warm-up, and are therefore energy efficient. In addition, because the core of the fuser member comprises glass or quartz, there is a real possibility that such fuser members can be recycled. Moreover, these cores allow for high thermal efficiency by providing superior insulation.

When the fuser member is a belt, the substrate can be of any desired or suitable material, including plastics, such as ULTEM®, available from General Electric, ULTRAPEK™, available from BASF, PPS (polyphenylene sulfide) sold under the tradenames FORTRON®, available from Hoechst Celanese, RYTON R-4®, available from Phillips Petroleum, and SUPEC®, available from General Electric; PAI(polyamide imide), sold under the tradename TORLON® 7130, available from Amoco; polyketone (PK), sold under the tradename KADEL® E1230, available from Amoco; PT (polyimide); polyaramide; PEEK (polyether ether ketone), sold under the tradename PEEK 450GL30, available from Victrex; polyphthalamide sold under the tradename AMODEL®, available from Amoco; PES (polyethersulfone); PEI (polyetherimide); PAEK (polyaryletherketone); PBA (polyparabanic acid); silicone resin; and fluorinated resin, such as PTFE (polytetrafluoroethylene); PFA (perfluoroalkoxy); FEP (fluorinated ethylene propylene); liquid crystalline resin (XYDAR®), available from Amoco; and the like, as well as mixtures thereof. These plastics can be filled with glass or other minerals to enhance their mechanical strength without changing their thermal properties. In embodiments, the plastic comprises a high temperature plastic with superior mechanical strength, such as polyphenylene sulfide, polyamide imide, polyimide, polyketone, polyphthalamide, polyether ether ketone, polyethersulfone, and polyetherimide. Suitable materials also include silicone rubbers. Examples of belt-configuration fuser members are disclosed in, for example, U.S. Pat. Nos. 5,487,707 and 5,514,436, the disclosures of each of which are totally incorporated herein by reference. A method for manufacturing reinforced seamless belts is disclosed in, for example, U.S. Pat. No. 5,409,557, the disclosure of which is totally incorporated herein by reference.

The fuser member may include an intermediate layer, which can be of any suitable or desired material. For example, the intermediate layer can comprise a silicone rubber of a thickness sufficient to form a conformable layer. Suitable silicone rubbers include room temperature vulcanization (RTV) silicone rubbers, high temperature vulcanization (HTV) silicone rubbers, and low temperature vulcanization (LTV) silicone rubbers. These rubbers are known and are readily available commercially such as SILASTIC® 735 black RTV and SILASTIC®732 RTV, both available from Dow Corning, and 106 RTV Silicone Rubber and 90 RTV Silicone Rubber, both available from General Electric. Other suitable silicone materials include the silanes, siloxanes (preferably polydimethylsiloxanes), such as fluorosilicones, dimethylsilicones, liquid silicone rubbers, such as vinyl crosslinked heat curable rubbers or silanol room temperature crosslinked materials, and the like. Other materials suitable for the intermediate layer include polyimides and fluoroelastomers. The intermediate layer may have a thickness of from about 0.05 to about 10 millimeters, such from about 0.1 to about 5 millimeters or from about 1 to about 3 millimeters.

The layers of the fuser member can be coated on the fuser member substrate by any desired or suitable means, including normal spraying, dipping, and tumble spraying techniques. A flow coating apparatus as described in U.S. Pat. No. 6,408,753, the disclosure of which is totally incorporated herein by reference, can also be used to flow coat a series of fuser members. In embodiments, the polymers may be diluted with a solvent, such as an environmentally friendly solvent, prior to application to the fuser substrate. Alternative methods, however, can be used for coating layers, including methods described in U.S. Pat. No. 6,099,673, the disclosure of which is totally incorporated herein by reference.

The outer layer of the fuser member may comprise a fluoropolymer such as polytetrafluoroethylene (PTFE), fluorinated ethylenepropylene copolymer (FEP), polyfluoroalkoxy (PFA), perfluoroalkoxy polytetrafluoroethylene (PFA TEFLON®), ethylene chlorotrifluoro ethylene (ECTFE), ethylene tetrafluoroethylene (ETFE), polytetrafluoroethylene perfluoromethylvinylether copolymer (MFA), combinations thereof and the like.

In embodiments, the outer layer may further comprise at least one filler. Examples of fillers suitable for use herein include a metal filler, a metal oxide filler, a doped metal oxide filler, a carbon filler, a polymer filler, a ceramic filler, and mixtures thereof.

In embodiments, an optional adhesive layer may be located between the substrate and the intermediate layer. In further embodiments, the optional adhesive layer may be provided between the intermediate layer and the outer layer. The optional adhesive intermediate layer may be selected from, for example, epoxy resins and polysiloxanes.

Embodiments described above will now be further illustrated by way of the following examples.

### EXAMPLES

### Example 1L

### Preparation of High Tg Latex A

A latex emulsion comprised of polymer particles generated from the emulsion polymerization of styrene (ST), n-butyl acrylate (BA) and beta-CEA was prepared as follows. A surfactant solution consisting of about 6.37 kilograms DOWFAX 2A1 (anionic emulsifier) and about 4096 kg deionized water was prepared by mixing for about 10 minutes in a stainless steel holding tank. The holding tank was then purged with nitrogen for about 5 minutes before being transferred into the reactor. The reactor was then continuously purged with nitrogen while being stirred at about 100 RPM. The reactor was then heated up to about 80° C. at a controlled rate, and held there.

Separately, about 64.5 kg of ammonium persulfate initiator was dissolved in about 359 kg of de-ionized water.

Separately, the monomer emulsion was prepared in the following manner. 3516.6 kg of styrene, about 787.7 kg of butyl acrylate and about 129.1 kg of beta-CEA, about 30.1 kg of 1-dodecanethiol (DDT), about 15.06 kg of decanediol diacrylate (ADOD), about 85.1 kg of DOWFAX 2A1 (anionic surfactant), and about 2048 kg of deionized water were mixed to form an emulsion. About 1% of the emulsion was then slowly fed into the reactor containing the aqueous surfactant phase at about 80° C. to form the “seeds” while being purged with nitrogen. The initiator solution was then slowly charged into the reactor and after about 10 minutes the rest of the emulsion was continuously fed in using a metering pump at a rate of about 0.5%/min. After about 100 minutes, half of the monomer emulsion had been added to the reactor. At this time, about 36.18 kilograms of 1-dodecanethiol was stirred into the monomer emulsion, and the emulsion was continuously fed in at a rate of about 0.5%/min. Also, at this time, the reactor stirrer was increased to about 350 RPM. Once all the monomer emulsion was charged into the main reactor, the temperature was held at about 80° C. for about an additional 2 hours to complete the reaction. Full cooling was then applied and the reactor temperature was reduced to about 35° C. The product was collected into a holding tank. After drying the latex the molecular properties were Mw=33,700 Mn=10,900, Mz=78,000, Mp=25,400, molecular weight distribution MWD=3.1, onset Tg was 58.6° C. and latex particle size=204 nanometers.

### Example 1G

### Preparation of Gel Latex

A latex emulsion comprised of polymer gel particles generated from the semi-continuous emulsion polymerization of styrene, n-butyl acrylate, divinylbenzene, and beta-CEA was prepared as follows.

A surfactant solution consisting of about 10.5 kilograms Tayca surfactant (anionic emulsifier) and about 7 kilograms de-ionized water was prepared by mixing in a stainless steel holding tank. The holding tank was then purged with nitrogen for about 5 minutes before about 30 percent of the surfactant solution was transferred into the reactor. About an additional 437.4 kilograms of de-ionized water was added into the reactor. The reactor was then continuously purged with nitrogen while being stirred at about 300 RPM. The reactor was then heated up to about 76° C. at about a controlled rate and held constant. In a separate container, about 3.72 kilograms of ammonium persulfate initiator was dissolved in about 39.4 kilograms of de-ionized water.

Also, in a second separate container, the monomer emulsion was prepared in the following manner. About 142.2 kilograms of styrene, about 76.56 kilograms of n-butyl acrylate, about 6.56 kilograms of beta-CEA, and about 2.187 kilograms of about 55% grade divinylbenzene, about 12.25 kilograms of Tayca solution (anionic surfactant), and about 236.2 kilograms of deionized water were mixed to form an emulsion. The ratio of the styrene monomer to the n-butyl acrylate monomer by weight was about 65 to about 35 percent.

About 1.5 percent of the above emulsion was then slowly fed into the reactor containing the aqueous surfactant phase at about 76° C. to form the “seeds” while being purged with nitrogen. The initiator solution was then slowly charged into the reactor and after about 20 minutes the rest of the emulsion was continuously fed in using metering pumps.

Once all the monomer emulsion was charged into the main reactor, the temperature was held at about 76° C. for about an additional 2 hours to complete the reaction. Full cooling was then applied and the reactor temperature was reduced to about 35° C. The product was collected into a holding tank after filtration through a 1 micron filter bag. After drying a portion of the latex, the onset Tg was about 41° C. The average particle size of the latex as measured by Microtrac was 44 nanometers and residual monomer as measured by Gas Chromatography as <50 ppm for styrene and <100 ppm for n-butyl acrylate.

### Example 1W

### Preparation of Wax Emulsion

About 904.8 grams of POLYWAX 850® polyethylene wax having a Mw of about 918, a Mn of about 850 and a melting point of about 107° C. purchased from Baker Petrolite and about 22.6 grams of NEOGEN RK™ anionic surfactant comprised primarily of branched sodium dodecyl benzenene sulphonate were added to about 3,016 grams of deionized water in an about 1 gallon reactor and stirred at about 400 RPM. The reactor mixture was heated to about 130° C. in order to melt the wax. The aqueous mixture containing the melted wax was then pumped through a Gaulin 15MR piston homogenizer at about 1 liter per minute for a period of about 30 minutes with the primary homogenizing valve fully open and the secondary homogenizing valve partially closed such that the homogenizing pressure was about 1,000 pounds per square inch.

Then, the primary homogenizing valve was partially closed such that the homogenizing pressure increased to about 8,000 pounds per square inch. The reactor mixture was still kept at about 130° C. and circulated through the homogenizer at about 1 liter per minute for about 60 minutes. Thereafter, the homogenizer was stopped and the reactor mixture was cooled to room temperature at about 15° C. per minute and discharged into a product container.

The resulting aqueous wax emulsion was comprised of about 31 percent by weight of wax, about 0.6 percent by weight of surfactant and about 68.4 percent by weight of water and had a volume average diameter of about 250 nanometers as measured with a HONEYWELL MICROTRAC®® UPA150 particle size analyzer.

### Example 1

### Preparation of Toner Particles A (10% Carbon Black, 5% Polyethylene Wax (Delayed Addition), and 10% Gel Latex)

The EA toner particles were prepared by mixing together about 324.1 kilograms of High Tg Latex A having a solids loading of about 41.6 weight percent, about 176.56 kilograms of black pigment dispersion PD-24 (Regal 330) having a solids loading of about 17 weight percent, about 112 kilograms of Gel Latex having a solids content of about 25 weight percent with about 776.7 kilograms of de-ionized water in a vessel while being stirred.

The entire mixture was homogenized through a Quadro homogenizer loop, and about 47.6 kilograms of a flocculent mixture containing about 4.76 kilograms polyaluminum chloride mixture and about 42.84 kilograms of about 0.02 molar nitric acid solution was added slowly into the homogenizer loop. The mixture was homogenized for about a further 20 minutes, then about 46.29 kilograms Wax Emulsion having a solids loading of about 31 weight percent was added via the homogenizer loop. The mixture was homogenized for about a further 30 minutes, then the homogenizer was stopped and the loop emptied back into the reactor.

The reactor jacket temperature was set to about 59° C. and the particles aggregated to a target size of about 4.8 micron as measured with a Coulter Counter. Upon reaching about 4.8 micron, about an additional 193.1 kilograms of High Tg Latex A was added and the particles grown to a target particle size of from about 5.85 to about 5.90 microns. The particle size was frozen by adjusting the reactor mixture pH to about 6.0 with about 1 molar sodium hydroxide solution.

Thereafter, the reactor mixture was heated at about 0.35° C. per minute to a temperature of about 85° C., followed by adjusting the reactor mixture pH to about 3.9 with about 0.3 M nitric acid solution. The reaction mixture was then ramped to about 96° C. at about 0.35° C. per minute.

At the start of particle coalescence, the pH was checked but not adjusted. The particle shape was monitored by measuring particle circularity using the Sysmex FPIA shape analyzer. Once the target circularity of about 0.959 was achieved, the pH was adjusted to about 7.0 with about 1 percent sodium hydroxide solution. Particle coalescence was continued for a total of about 2.5 hours at about 96° C.

The particles were cooled to about 63° C. At about 63° C., the slurry was treated with about 4 percent sodium hydroxide solution to a pH of about 10 for about 60 minutes followed by cooling to about room temperature, approximately 25° C.

The toner of this mixture comprised about 75 percent of styrene/acrylate polymer, about 10 percent of REGAL 330 pigment, about 5 percent by weight of POLYWAX 850® and about 10 percent by weight of Gel Latex. The particles were washed 3 times after removal of the mother liquor as follows: one wash with de-ionized water at room temperature, one wash carried out at a pH of about 4.0 at about 40° C., and finally the last wash with de-ionized water at about room temperature.

After drying the particles in an Aljet dryer, the final average particle size d50=5.89 microns, GSD by volume of 1.2, GSD by number of 1.23, percent fines (<4.0 microns) of 12.8%, particle circularity of 0.963.

Toner Particles A are designated as Toner 10 in Table 2.

The toner described in Example 1 showed excellent document and vinyl offset performance. However, the half tone rub performance was insufficient. Therefore, other waxes and wax loadings in combination with latexes having lower glass transition temperatures were explored, as set forth in more detail below. A series of toners were made according to the delayed wax procedure described in Example 1, using latexes of varying Tg's. The High Tg Latexes were made as described in Example 1L, but with varying ratios of styrene and butyl acrylate and changes in the surfactant partition. Surfactant partition refers to the percent of the total Dowfax added to the water in the reactor and the monomer emulsion i.e. for all latexes the same total amount of Dowfax was added, but the initial split between the reactor and the monomer emulsion tank varied slightly. The High Tg Latexes used and their formulation are listed below in Table 1.

TABLE 1
High Tg Latexes with Varying Glass Transition
Temperatures For Further Examples

| | | High Tg | High Tg | High Tg | High Tg |
|---|---|---|---|---|---|
| | | Latex B | Latex C | Latex D | Latex E |
| Formulation | ST/BA | 78.2/21.8 | 79.3/20.7 | 80.4/19.6 | 81.7/18.3 |
| | Weight | | | | |
| | Ratio | | | | |
| | DDT | 0.7/2.38 | 0.7/2.38 | 0.7/2.38 | 0.7/2.38 |
| | (pph) | | | | |
| | Surfactant | 6.5/93.5 | 6/94 | 5.5/94.5 | 5/95 |
| | Partition | | | | |
| Results | Mw | 33,700 | 34,700 | 34,000 | 34,500 |
| | Mn | 10,600 | 11,800 | 11,800 | 11,300 |
| | Tg (° C.) | 53.0 | 55.0 | 56.7 | 59.4 |
| | Particle | 209 | 205 | 199 | 218 |
| | Size (nm) | | | | |
| | Solids (%) | 41.6 | 41.6 | 40.2 | 41.7 |

Also, toners were made with bulk wax added, that is, the wax was added before addition of the flocculent, at various loading amounts. Wax emulsions were made as described in Example 1W, but using POLYWAX 725® wax (Mw of 783, Mn of 725 and a melting point of 104° C.) and POLYWAX 655® (Mw of 707, Mn of 655 and a melting point of 99° C.).

Example 2 describes the preparation of a higher wax toner, and Table 2 lists the toners made according to the process of Example 1 (delayed wax) and the process of Example 2 (bulk wax) and evaluated for fusing latitude and blocking.

### Example 2

### Preparation of Toner Particles with a Higher Wax Content (10% Carbon Black, 12% POLYWAX 725® Polyethylene Wax, 10% Gel Latex)

The particles were prepared by mixing together about 256.1 kilograms of High Tg Latex C having a solids loading of about 41.6 weight percent, about 103.16 kilograms of POLYWAX 725® wax emulsion having a solids loading of about 31 weight percent, about 163.95 kilograms of black pigment dispersion (REGAL 330®) having a solids loading of about 17 weight percent, about 104 kilograms of Gel Latex having a solids content of about 25 weight percent with about 811.9 kilograms of de-ionized water in a vessel while being stirred. The entire mixture was homogenized through a Quadro homogenizer loop, and about 44.20 kilograms of a flocculent mixture containing about 4.42 kilograms polyaluminum chloride mixture and about 39.78 kilograms of about 0.02 molar nitric acid solution was added slowly into the homogenizer loop.

The mixture was homogenized for about a further 60 minutes, then the homogenizer was stopped and the loop emptied back into the reactor. The reactor jacket temperature was set to about 59° C. and the particles aggregated to a target size of about 4.8 micron as measured with a Coulter Counter. Upon reaching about 4.8 micron, about an additional 179.3 kilograms of High Tg Latex C was added and the particles were grown to the target particle size of from about 5.85 to about 5.90 microns. The particle size was frozen by adjusting the reactor mixture pH to about 6.0 with about 1 molar sodium hydroxide solution.

Thereafter, the reactor mixture was heated at about 0.35° C. per minute to a temperature of about 85° C., followed by adjusting the reactor mixture pH to about 3.9 with about 0.3 M nitric acid solution. The reaction mixture was then ramped to about 96° C. at about 0.35° C. per minute.

At the start of particle coalescence the pH was checked but not adjusted. The particle shape was monitored by measuring particle circularity using the Sysmex FPIA shape analyzer. Once the target circularity of about 0.958 was achieved, the pH was adjusted to about 7.0 with about 1 percent sodium hydroxide solution. Particle coalescence was continued for a total of about 2.5 hours at about 96° C. The particles were cooled at a control rate of about 0.6° C. per minute to about 63° C. At about 63° C., the slurry was treated with about 4 percent sodium hydroxide solution to a pH of about 10 for about 20 minutes followed by cooling to about room temperature.

The toner of this mixture comprised about 68 percent of styrene/acrylate polymer, about 10 percent of REGAL 330 pigment, about 12 percent by weight of POLYWAX 725 and about 10 percent by weight of Gel Latex. The particles were washed 3 times after removal of the mother liquor as follows: one wash with de-ionized water at about room temperature, one wash carried out at a pH of about 4.0 at about 40° C., and finally the last wash with de-ionized water at about room temperature.

After drying the particles in an Aljet dryer the final average particle size d50=5.89 microns, GSD by volume of 1.21, GSD by number of 1.26, percent fines (<4.0 microns) of 15.7%, particle circularity of 0.959, and toner onset Tg was

Toner particles with a higher wax content as set forth in Example 2 are designated as Toner 5 in Table 2.

TABLE 2
Toners Made With High Tg Latexes Having Various Glass
Transition Temperatures with Various Waxes and Wax Loading Methods

| | High Tg | Toner Making | | |
|---|---|---|---|---|
| | Latex | Method | % Wax | Wax |
| Toner 1 | B | Example 1 | 5 | POLYWAX 850 ® |
| Toner 2 | B | Example 2 | 12 | POLYWAX 725 ® |
| Toner 3 | B | Example 2 | 12 | POLYWAX 655 ® |
| Toner 4 | C | Example 1 | 5 | POLYWAX 850 ® |
| Toner 5 | C | Example 2 | 12 | POLYWAX 725 ® |
| Toner 6 | C | Example 2 | 12 | POLYWAX 655 ® |
| Toner 7 | D | Example 1 | 5 | POLYWAX 850 ® |
| Toner 8 | D | Example 2 | 12 | POLYWAX 725 ® |
| Toner 9 | D | Example 2 | 12 | POLYWAX 655 ® |
| Toner 10 | A | Example 1 | 5 | POLYWAX 850 ® |
| Toner 11 | E | Example 2 | 12 | POLYWAX 725 ® |
| Toner 12 | E | Example 2 | 12 | POLYWAX 655 ® |

All toners of Table 2 were made successfully. Decreasing the glass transition temperature of the High Tg Latex used in the toner formulation improved both crease and half-tone rub. In addition, switching from POLYWAX 850® to POLYWAX 725® in the toner formulation appeared to improve crease and halftone rub, especially when the glass transition temperature of the High Tg Latex used in the toner formulation was lowered.

Document offset and heat cohesion data were also obtained. Document offset was improved in toner formulation which utilized POLWAX 725® and the wax was loaded in bulk form. All of document offset, vinyl offset and heat cohesion improved when the toner formulation included a High Tg Latex having an increased glass transition temperature. However, no significant difference was demonstrated in heat cohesion when the toner formulation included POLYWAX 850® or POLYWAX 725.

As demonstrated below in Table 3, each of the toner formulations summarized in the Table demonstrated acceptable blocking temperatures within a range of from about 52° C. to about 60° C.

TABLE 3
Blocking Temperature

| | High Tg | | | Blocking |
|---|---|---|---|---|
| | Latex | Wax Type | Wax % | Temperature |
| Toner 1 | B | POLYWAX ® 850 | 5 | 55° C. |
| Toner 2 | B | POLYWAX ® 725 | 12 | 54° C. |
| Toner 4 | C | POLYWAX ® 850 | 5 | 57° C. |
| Toner 5 | C | POLYWAX ® 725 | 12 | 56° C. |
| Toner 7 | D | POLYWAX ® 850 | 5 | 56° C. |
| Toner 8 | D | POLYWAX ® 725 | 12 | >57° C. |

Based on the results of the above experiments, the optimum formulation to obtain the most acceptable crease and half tone rub performance, while still achieving acceptable document offset, vinyl offset and heat cohesion was to utilize about 12 percent POLYWAX 725®, and a High Tg Latex having a glass transition temperature of about 55° C. Tg latex (described in Example 2).

Document offset samples were imaged onto paper at about 0.50 mg/cm² for before being fused. Toner to toner, and toner to paper, images were cut from a sheet of about 5 cm by about 5 cm, and placed under an about 80 g/cm² load at about 60° C. and about 50% RH, and tested at those conditions for about 24 hours. After the samples were removed from the chamber and cooled to room temperature, the sheets of paper were peeled apart using about an 180° peel angle. To enhance the amount of toner being transferred to paper (toner-to-paper document offset), the top sheet being pulled at about 180° angle had toner while the bottom sheet was blank paper. In both cases, the bottom sheet was held flat against a smooth surface while the top sheet was slowly peeled away. Document offset samples were ranked using the Standard Image Reference (SIR) in which Grade 5 indicates no damage and Grade 1 indicates severe damage.

TABLE 4
Document Offset Data

| | | | | SIR | SIR |
|---|---|---|---|---|---|
| | Latex Tg | Wax Type | Wax % | Toner-Toner | Toner-Paper |
| Toner 1 | 53 | PW850 | 5 | 3.5 | 4.0 |
| Toner 2 | 53 | PW725 | 12 | 4.5 | 4.0 |
| Toner 5 | 55 | PW725 | 12 | 4.25 | 4.0 |
| Toner 10 | 59 | PW850 | 5 | 4.5 | 4.75 |
| Toner 11 | 59 | PW725 | 12 | 4.0 | 5.0 |
| Toner 12 | 59 | PW655 | 12 | 4.5 | 4.75 |

Vinyl offset was evaluated by cutting a print section of about 5 cm by about 5 cm, from a fused print, covered with a piece of standard vinyl, and then placed between glass slides, loaded with about 250 g weight, and moved into an environmental oven at a load of about 10 g/cm², about 50° C. and about 50% RH for about 24 hours. The samples were cooled, carefully peeled apart, and compared to a SIR. Grade 5 indicates no toner offset onto vinyl and no disruption of the image gloss. Grade 4.5 indicates no toner offset, but some disruption of image gloss. Grades of about 4 to about 1 indicate progressively higher amounts of toner offset onto the vinyl, from slight (5) to severe (1). In general, an acceptable Grade is greater than about 4.

TABLE 5
Vinyl Offset Data

| | | Wax | | Vinyl Offset |
|---|---|---|---|---|
| | Latex Tg | Type | Wax % | SIR |
| Toner 1 | 53 | PW850 | 5 | 3.5 |
| Toner 2 | 53 | PW725 | 12 | 4.0 |
| Toner 4 | 55 | PW850 | 5 | 4.0 |
| Toner 5 | 55 | PW725 | 12 | 4.0 |
| Toner 10 | 59 | PW850 | 5 | 4.25 |
| Toner 11 | 59 | PW725 | 12 | 4.0 |
| Toner 12 | 59 | PW655 | 12 | 4.0 |

Rub fix measurements were conducted with 50% halftone images fused onto the thick rough paper stock. A Taber Linear Abraser (model 5700) with the crock attachment and standard crock cloths was used to test the nib fix of the toner. The test conditions included adding a 500 gram load to the crock attachment, and the print was then rubbed for two cycles at about 60 cps over about a two inch span. After the sample was rubbed the crock cloth was removed, the transmission optical density of the toner on the crock cloth was measured using a Greatag/Macbeth Spectroscan Transmission densitometer. The rub fix data for several toners is shown below in Table 6.

TABLE 6
Rub Fix Data

| | Latex Tg | Wax Type | Wax % | ODtr |
|---|---|---|---|---|
| Toner 1 | 53 | PW850 | 5 | 0.12 |
| Toner 2 | 53 | PW725 | 12 | 0.08 |
| Toner 4 | 55 | PW850 | 5 | 0 |
| Toner 5 | 55 | PW725 | 12 | 0.08 |
| Toner 10 | 59 | PW850 | 5 | 0.18 |
| Toner 11 | 59 | PW725 | 12 | 0.17 |

It will be appreciated that various of the above-disclosed and other feature and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of the claims should not be implied or imported from the specification or any other claims as to any particular order, number, position, size, shape, angle, color, or material.

What is claimed is:

1. An image forming device, comprising:
a development system including an emulsion/aggregation toner, and
a fuser member,
wherein the emulsion/aggregation toner comprises a gel latex, a high Tg latex, a wax, and a colorant, and
wherein the fuser member comprises a substrate and an outer layer comprising a fluoropolymer.

2. The image forming device according to claim 1, wherein the fluoropolymer is selected from the group consisting of polytetrafluoroethylene, fluorinated ethylenepropylene copolymer, polyfluoroalkoxy, perfluoroalkoxy polytetrafluoroethylene, ethylene chlorotrifluoro ethylene, ethylene tetrafluoroethylene, polytetrafluoroethylene perfluoromethylvinylether copolymer, and polymers thereof.

3. The image forming device according to claim 1, wherein the fuser member further comprises an intermediate layer positioned between the substrate and the outer layer.

4. The image forming device according to claim 3, wherein the intermediate layer comprises silicone rubber.

5. The image forming device according to claim 1, where the outer layer further comprises a filler.

6. The image forming device according to claim 5, the filler is selected from the group consisting of a metal filler, a metal oxide filler, a doped metal oxide filler, a carbon filler, a polymer filler, a ceramic filler and mixtures thereof.

7. The image forming device according to claim 1, wherein the substrate is a roller or a belt.

8. The image forming device according to claim 1, wherein the development system is a semi-conductive magnetic brush development system.

9. The image forming device according to claim 1, wherein a latitude of the gel latex around about a centerline particle formulation is about 10 weight percent±about 2 weight percent, a latitude of the high Tg latex around about a centerline particle formulation is about 68 weight percent±about 2 weight percent, a latitude of the wax around about a centerline particle formulation is about 12 weight percent±about 1 weight percent, and a latitude of the colorant around about a centerline particle formulation is about 11 weight percent±about 1 weight percent.

10. The image forming device according to claim 1, wherein a crosslinked density of the gel latex is from about 0.3 to about 40, and a crosslinked density of the high Tg latex is less than about 0.1.

11. The image forming device according to claim 1, wherein the high Tg latex has a glass transition temperature of from about 53° C. to about 58° C.

12. The image forming device according to claim 1, wherein the wax is an aliphatic wax, a polyethylene wax, a polypropylene wax, or mixtures thereof.

13. The image forming device according to claim 1, wherein the high Tg latex is selected from the group consisting of styrene acrylates, styrene methacrylates, butadienes, isoprene, acrylonitrile, acrylic acid, methacrylic acid, beta-carboxyethylacrylate, polyesters, poly(styrene-butadiene), poly(methyl styrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methyl styrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene); poly(styrene-propyl acrylate), poly(styrene-butyl acrylate), poly(styrene-butadiene-acrylic acid), poly(styrene-butadiene-methacrylic acid), poly(styrene-butyl acrylate-acrylic acid), poly(styrene-butyl acrylate-methacrylic acid), poly(styrene-butyl acrylate-acrylonitrile), poly(styrene-butyl acrylate-acrylonitrile-acrylic acid), and styrene/butyl acrylate/carboxylic acid terpolymers, styrene/butyl acrylate/beta-carboxyethylacrylate terpolymers, and mixtures thereof.

14. The image forming device according to claim 1, wherein the emulsion/aggregation toner further comprises a flocculant, wherein a latitude of the flocculant around about a centerline particle formulation is about 0.17 weight percent±about 0.02 weight percent.

15. The image forming device according to claim 1, wherein the emulsion/aggregation toner exhibits a document offset of at least about Grade 3, a vinyl offset of at least about Grade 3, a rub fix of less than or equal to about 0.20 Odtr, and a blocking temperature of from about 52° C. to about 60° C.

16. An image forming process, comprising:
forming an electrostatic image on a photoconductive member;
developing the electrostatic image to form a visible image by depositing emulsion aggregation toner particles on a surface of the photoconductive member; and
transferring the visible image to a substrate and fixing the visible image to the substrate with a fuser member;
wherein the emulsion/aggregation toner comprises a gel latex, a high Tg latex, a wax, and a colorant, and
wherein the fuser member comprises a substrate and an outer layer comprising a fluoropolymer.

17. The image forming process according to claim 16, wherein the fluoropolymer is selected from the group consisting of polytetrafluoroethylene, fluorinated ethylenepropylene copolymer, polyfluoroalkoxy, perfluoroalkoxy polytetrafluoroethylene, ethylene chlorotrifluoro ethylene, ethylene tetratluoroethylene, polytetrafluoroethylene perfluoromethylvinylether copolymer, and combinations thereof.

18. The image forming process according to claim 16, wherein the fuser member further comprises an intermediate layer positioned between the substrate and the outer layer.

19. The image forming process according to claim 18, wherein the intermediate layer comprises silicone rubber.

20. The image forming process according to claim 16, where the outer layer further comprises a filler.

21. The image forming process according to claim 20, wherein the filler is selected from the group consisting of a metal filler, a metal oxide filler, a doped metal oxide filler, a carbon filler, a polymer filler, a ceramic filler and mixtures thereof.

22. The image forming process according to claim 16, wherein the substrate is a roller or a belt.

23. The image forming process according to claim 16, wherein a conductive magnetic brush development system develops the electrostatic image.

24. The image forming process according to claim 16, wherein a latitude of the gel latex around about a centerline particle formulation is about 10 weight percent±about 2 weight percent, a latitude of the high Tg latex around about a centerline particle formulation is about 68 weight percent±about 2 weight percent, a latitude of the wax around about a centerline particle formulation is about 12 weight percent±about 1 weight percent, and a latitude of the colorant around about a centerline particle formulation is about 11 weight percent about 1 weight percent.

25. The image forming process according to claim 16, wherein a crosslinked density of the gel latex is from about 0.3 to about 40, and a crosslinked density of the high Tg latex is less than about 0.1.

26. The image forming process according to claim 16, wherein the high Tg latex has a glass transition temperature of from about 53° C. to about 58° C.

27. The image forming process according to claim 16, wherein the wax is an aliphatic wax, a polyethylene wax, a polypropylene wax, or mixtures thereof.

28. A toner composition having emulsion/aggregation toner particles comprising:
a gel latex,
a high Tg latex,
a wax, and
a colorant,
wherein a latitude of the gel latex around about a centerline particle formulation is about 10 weight percent±about 2 weight percent, a latitude of the high Tg latex around about a centerline particle formulation is about 68 weight percent±about 2 weight percent, a latitude of the wax around about a centerline particle formulation is about 12 weight percent±about 1 weight percent, and a latitude of the colorant around about a centerline particle formulation is about 10 weight percent about 1 weight percent, and
wherein the high Tg latex has a glass transition temperature of from about 53° C. to about 58° C.
